(19) United States
(12) Patent Application Publication
(10) Pub. No.: US 2025/0245894 A1
(43) Pub. Date: Jul. 31, 2025

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: WATARU SAITO, Kanagawa (JP)

(21) Appl. No.: 19/039,561

(22) Filed: Jan. 28, 2025

(30) Foreign Application Priority Data
Jan. 30, 2024 (JP) 2024-011963

(51) Int. Cl. G06T 11/60; G06T 3/40

(52) U.S. Cl. CPC G06T 11/60; G06T 3/40

(57) ABSTRACT

An information processing apparatus includes one or more processors executing instructions to perform output processing of outputting reproduction data to a save location, the reproduction data being for reproducing a layout created using a layout editing application, perform generation processing of generating an image file related to the layout, perform first addition processing of adding information indicative of the save location to the image file generated in the generation processing, and perform second addition processing of adding identification information for identifying the layout editing application to the image file.

### BACKGROUND

### Field of the Disclosure

The present disclosure relates to an information processing apparatus, a method for controlling the information processing apparatus, and a storage medium.

### Description of the Related Art

There are various layout editing applications for creating design content such as a poster, a flyer, or a photo album by laying out objects such as an image, text, or a graphic. The design content created using a layout editing application can be printed by a printer and put up or can be saved to an image file and published on a web page or on a social networking service (SNS).

Some layout editing applications can save layout reproduction data to external data (an external file). Such external data is usually in a file format unique to the application, and the extension of the file is also unique to the application. Thus, to check the contents of the layout, the data needs to be opened in the corresponding application. Meanwhile, outputting layout contents to an image file in a universally prevalent format such as JPEG allows the layout to be viewed using, e.g., a typical image viewer application with which an operating system (OS) is equipped.

Japanese Patent Laid-Open No. 2017-29509 (hereinafter referred to as Literature 1) describes a method in which, in saving reproduction data of an application, a screen capture image and the main body of reproduction data are saved to a server, with an URL to the save location of the reproduction data being recorded in metadata of the capture image. The method of Literature 1 allows a user to check the state of the screen at the time of data saving by viewing the capture image and also to download the reproduction data by referring to the URL in the metadata. Using this method also allows the layout editing application to be used to view the layout content easily and to output an image file which enables reference to layout reproduction data.

With the technique of Literature 1, an image file which enables reference to reproduction data and an image file which is merely a file to which layout contents have been outputted cannot be differentiated from each other. For example, in a case where they are saved to the same folder, they cannot be distinguished from each other by appearance because they are both same image files. It is therefore difficult for a user to select a file in the event where the user wants to refer to reproduction data to reproduce a layout on a layout editing application.

### SUMMARY

An information processing apparatus according to embodiments of the present disclosure has: one or more memories storing instructions; and one or more processors executing the instructions to perform output processing of outputting reproduction data to a save location, the reproduction data being for reproducing a layout created using a layout editing application, perform generation processing of generating an image file related to the layout, perform first addition processing of adding information indicative of the save location to the image file generated in the generation processing, and perform second addition processing of adding identification information for identifying the layout editing application to the image file.

Further features of the present disclosure will become apparent from the following description of exemplary embodiments with reference to the attached drawings.

### BRIEF DESCRIPTION OF THE DRAWINGS

FIG. 1 is a diagram showing an example configuration of an information processing system.

FIG. 2 is a diagram showing an edit screen of a layout editing application.

FIG. 3 is a flowchart showing an example of image file outputting processing.

FIG. 4 is a diagram showing an example of an image file.

FIG. 5 is a flowchart showing an example of layout reproduction processing.

FIG. 6 is a flowchart showing an example of file list displaying processing.

FIG. 7 is a diagram showing an example of how a file list is displayed.

FIG. 8 is a flowchart showing an example of image file outputting processing.

FIG. 9 is a flowchart showing an example of layout reproduction processing.

FIG. 10 is a diagram showing an example of an icon edit screen.

FIG. 11 is a diagram showing an example of an icon edit screen.

FIG. 12 is a diagram showing an example of an icon edit screen.

FIG. 13 is a diagram showing a different example of an icon.

FIG. 14 is a diagram showing a different example of an icon.

### DESCRIPTION OF THE EMBODIMENTS

Embodiments of the present disclosure are described in detail below with reference to the drawings attached hereto. Note that the following embodiments do not limit the matters of the present disclosure, and not all combinations of features described in the following embodiments are necessarily essential as solutions provided by the present disclosure. Note that the same constituents are denoted by the same reference number.

### First Embodiment

### Information Processing System

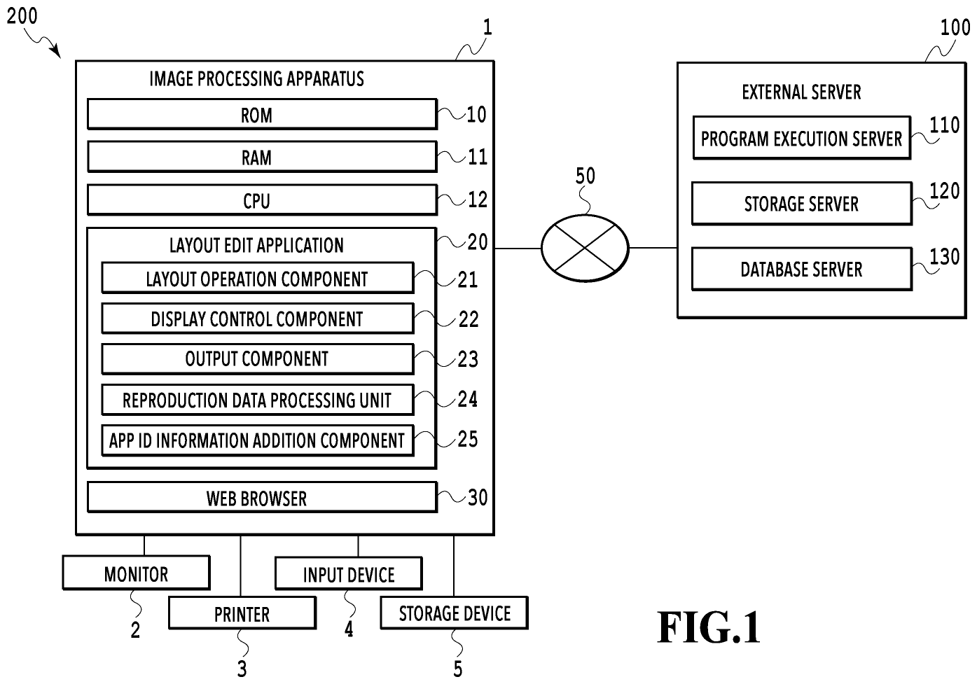

FIG. 1 is a diagram showing an example configuration of an information processing system 200 of the present embodiment. The information processing system 200 has an information processing apparatus 1, an external server 100, and a network 50.

The information processing apparatus 1 has a ROM 10, a RAM 11, and a CPU 12. The information processing apparatus 1 has input/output interfaces (not shown) for connecting to a monitor 2, a printer 3, an input device 4, a storage device 5, and the network 50. The CPU 12 is a central processing unit and performs overall control of the information processing apparatus 1 by executing the OS stored in the storage device 5, the ROM 10, or the RAM 11. Also, by executing programs stored in the ROM 10 or the RAM 11, the CPU 12 implements each application configuration installed in the information processing apparatus 1, computes or processes information, and controls and executes each piece of hardware. The ROM 10 is read-only memory and has programs stored therein. The RAM 11 is random-access memory and is used as work memory for the CPU 12. In a case where the RAM 11 is non-volatile RAM, the programs may be stored in the RAM 11. The programs stored in the ROM 10 or the RAM 11 may include a layout editing application 20 to be described later.

The monitor 2 is a display apparatus configured to display an image outputted from an application executed by the information processing apparatus 1. The printer 3 is a device configured to print out an image outputted from an application executed by the information processing apparatus 1. The input device 4 is a keyboard, a pointing device, or a touch panel used to operate, e.g., a GUI screen for the OS and an application executed by the information processing apparatus 1. The input device 4 is also an interface for importing an image from external USB memory, an external HDD device, or the like. Depending on its form, the input device may be integral with the monitor and configured as, e.g., a touch panel directly touched for entry of information. The storage device 5 is a storage device such as an HDD or an SSD in which to save, e.g., images for input or various information saving files or images outputted from, e.g., applications installed in the information processing apparatus 1.

In FIG. 1, the monitor 2, the input device 4, and the storage device 5 are shown as separate devices from the information processing apparatus 1. However, depending on the form of the information processing apparatus 1, they may be integral, and the information processing apparatus 1 may include, as its constituents, the monitor 2, the input device 4, and the storage device 5 (which may be shared with the RAM of the information processing apparatus 1).

The information processing apparatus 1 has the layout editing application 20 and a web browser 30. Although FIG. 1 shows the layout editing application 20 independently for illustration, the layout editing application 20 is a program stored in the ROM 10, the RAM 11, or the like. The CPU 12 functions as the layout editing application 20 by executing the program for the layout editing application 20. Similarly, the web browser 30 is also a program stored in the ROM 10, the RAM 11, or the like. The CPU 12 functions as the web browser 30 by executing the program for the web browser 30.

The layout editing application 20 is an application installed in the information processing apparatus 1 and is an application for creating design content. Examples of the design content include a poster, a flyer, and a photo album. They are content created by laying out and editing objects such as an image, text, or a graphic. Although the layout editing application 20 is installed in the information processing apparatus 1 in the example described in the present embodiment, it is to be noted that the layout editing application 20 may be provided in the form of a web application operated on the web browser.

The layout editing application 20 has a layout operation component 21, a display control component 22, an output component 23, a reproduction data processing component 24, and an app ID information adding component 25. The layout operation component 21 is an operation receiving component configured to receive a layout operation performed through the input device 4. The display control component 22 displays an edit user interface (UI) screen for the layout editing application 20 on the monitor 2.

The output component 23 performs output of layout reproduction data and transfer thereof to a save location and performs output of an image file of the contents of a layout in an image form (hereinafter referred to as a layout image file). Layout reproduction data is data for reproducing a layout edited on the layout editing application 20 and is saved as an external file of the layout editing application 20. Typically, layout reproduction data is in a file format unique to the layout editing application 20, and the file extension is also unique to the layout editing application 20.

The reproduction data processing component 24 adds a save location of layout reproduction data to an image outputted from the output component 23 and also obtains a save location of reproduction data from an image. The app ID information adding component 25 adds information for identifying the layout editing application to an image outputted by the output component 23.

The web browser 30 allows a user to view a website on the Internet and executes a web application.

The network 50 is a communication network connected to the information processing apparatus 1 and the external server 100 to allow communications of information between the information processing apparatus 1 and the external server 100 that are connected thereto.

The external server 100 has a program execution server 110, a storage server 120, and a database server 130. Also, the external server 100 has an input/output interface (not shown) for connecting to the network 50 such as the Internet. The program execution server 110 includes a processor configured to execute part of processing performed by the layout editing application 20 or equivalent processing, as needed. For example, in a case where the layout editing application 20 is in the form of a web application, the program execution server 110 implements the functions of the layout editing application 20. The storage server 120 holds, e.g., layout reproduction data files and images transferred thereto from the layout editing application 20 via the network 50. The database server 130 holds, e.g., layout-related information, user-related information, or information to be shared between users transferred thereto from the layout editing application 20 via the network 50. The program execution server 110, the storage server 120, and the database server 130 may be placed in physically different processing devices or in the same processing device. In other words, the external server 100 may be a server system including at least one server device.

### Layout Editing Application

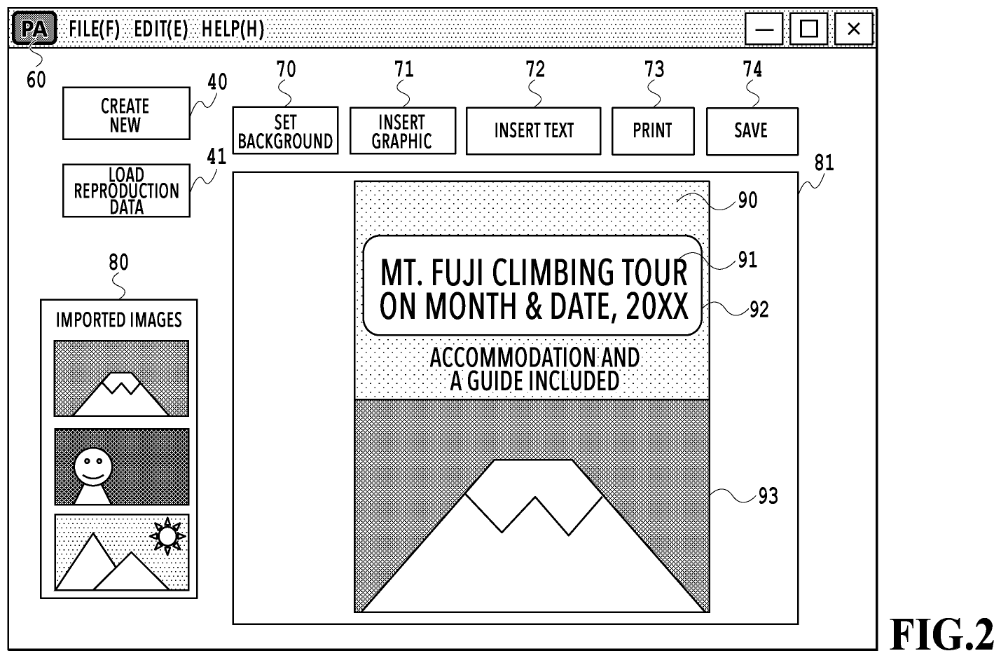

FIG. 2 is a diagram showing an edit screen of the layout editing application 20. An icon 60 is an icon unique to the layout editing application 20. An edit region 81 is a region for editing a layout. In the edit region 81, a layout operation such as adjusting the position of an image or text object can be performed. A Create New button 40 and a Load Reproduction Data button 41 represent button regions for selecting and managing layout content. For example, in a case where the Create New button 40 is pressed by a user, the layout editing application 20 can initialize the edit region 81 and create a new layout. Note that “press” herein may include various operations such as a click, a touch, and a tap. In a case where the Load Reproduction Data button 41 is pressed by a user, the layout editing application 20 can receive selection of a reproduction data file to load. For example, the display control component 22 displays, on the screen, a list of reproduction data files existing in the currently selected folder, so as to be able to receive selection of a file to load made by a user operation. Once a reproduction data file is selected on the file list screen, the reproduction data processing component 24 reproduces the layout on the edit region 81.

Buttons 70 to 73 represent button regions used to perform layout operations on the edit region 81. For example, upon reception of pressing of a Set Background button 70 from a user, the layout editing application 20 can set a background color, a background image, or the like. Upon reception of pressing of an Insert Graphic button 71 from a user, the layout editing application 20 can insert a graphic into the edit region 81. Upon reception of pressing of an Insert Text button 72 from a user, the layout editing application 20 can insert text to the edit region 81. Upon reception of pressing of a Print button 73 from a user, the layout editing application 20 can output an instruction to have the layout printed by the printer 3 or a printer or the like (not shown) connected to the network. Upon reception of pressing of a Save button 74 from a user, the layout editing application 20 can output the contents of the layout in the edit region 81 to a layout reproduction data file or an image file.

An image list region 80 is a region for displaying a list of images imported to the layout editing application 20. FIG. 2 shows a scenario where three images have been imported in total. For example, once a user clicks, touches, or drags and drops a thumbnail image on the image list, the layout editing application 20 can lay the target image out on the edit region 81. A background region 90 represents the background of the layout. A text region 91, a graphic region 92, and an image region 93 represent text, a graphic, and an image laid out in the edit region 81, respectively.

### Image File Outputting Processing

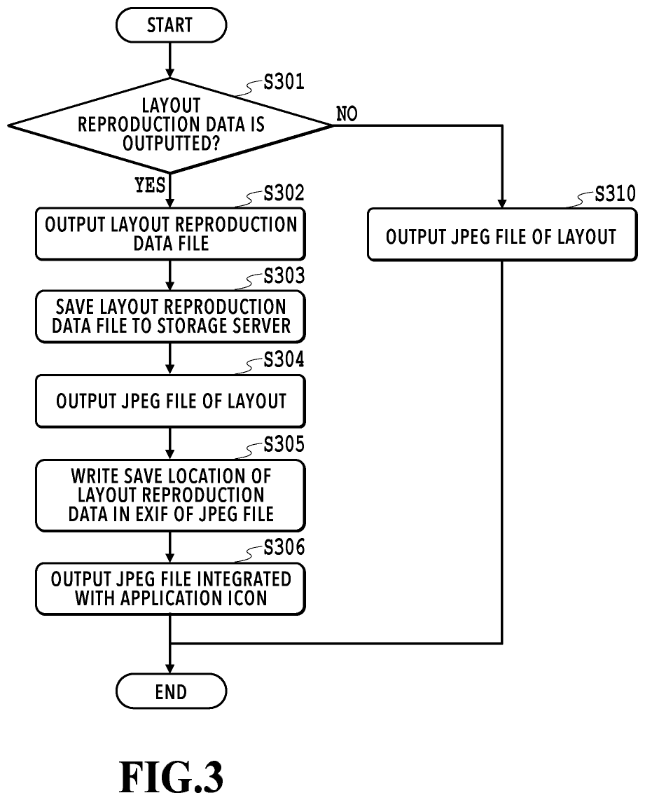

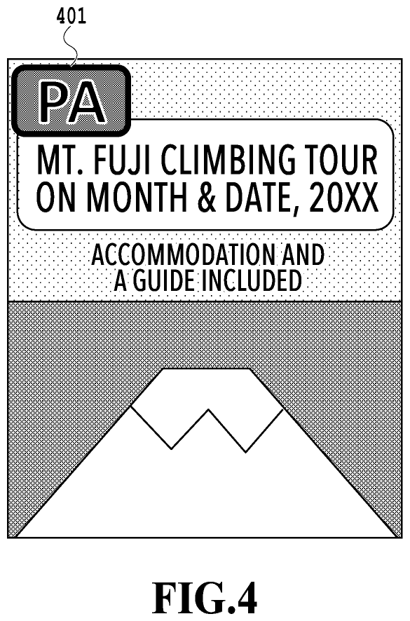

Next, processing performed by the layout editing application 20 to output an image file which enables a user to know whether layout reproduction data can be referred to is described using FIGS. 3 and 4.

FIG. 3 is a flowchart showing an example of image file outputting processing. FIG. 4 is a diagram showing an example image file which enables a user to know that layout reproduction data can be referred to.

The processing shown in FIG. 3 is implemented by the CPU 12 of the information processing apparatus 1 by reading in the RAM 11 and executing a program stored in the ROM 10, the storage device 5, or the like. In other words, the processing shown in FIG. 3 is implemented by the CPU 12 functioning as the components of the layout editing application 20 shown in FIG. 1. Note that some or all of the functions in the steps in FIG. 3 may be implemented by hardware such as an ASIC or an electronic circuit. The letter “S” in the descriptions of the processing means that it is a step in the flowchart (this applies to the other flowcharts herein as well). The flowchart in FIG. 3 is processing started once the Save button 74 shown in FIG. 2 is pressed by a user.

In S301, the CPU 12 functioning as the output component 23 determines, based on the user's selection operation, whether to output layout reproduction data or to output a layout image. For example, once the Save button 74 is pressed by the user, a selection screen (not shown) is displayed, and the CPU 12 can make the determination in S301 based on a selection operation received on the selection screen. If it is determined to output layout reproduction data, the CPU 12 proceeds to S302. If it is determined not to output layout reproduction data, the CPU 12 proceeds to S310.

In S310, the CPU 12 functioning as the output component 23 generates a Joint Photographic Experts Group (JPEG) file by rendering (bitmapping) the current contents of the layout. The CPU 12 then outputs the generated JPEG file (an image file) to a user-designated save location and ends the processing of the flowchart in FIG. 3. Note that in a case where the layout editing application 20 is a native application, the rendering method may be, for example, using an image encoder of a development platform conforming to each OS, and in a case where the layout editing application 20 is a web application, the rendering method may be using a screenshot function of a web browser. Note that the format of the image file is not limited to JPEG. The format may be any format that can be incorporated into metadata and opened in an image viewer application in the OS that can start up the layout editing application 20. For example, the image file generated by the layout editing application 20 may be in an image format such as Portable Network Graphics (PNG), Tag Image File Format (TIFF), or the like. Note that the format used herein to output an image of a layout is JPEG.

The JPEG file outputted in S310 is image data representing the current contents of the layout, but may be image data from which the current contents of the layout can be identified. In other words, the file is not limited to image data obtained by rendering the contents of the layout as long as the image data includes an image related to the contents of the layout. For example, the file may be data on not the image of the edit region 81, but an image of the entire screen shown in FIG. 2. Also, the file may be image data including, as at least part of the image content, an image of image data used for the layout (the image data selected in the image list region 80).

In S302, the CPU 12 functioning as the output component 23 outputs a layout reproduction data file. The layout reproduction data may have a structure suitable for internal processing in the layout editing application 20. For example, layout reproduction data may hold, in a predetermined format, the disposition coordinates, sizes, decoration information, or the like of objects laid out, such as text and graphics. Examples of the predetermined format include, but are not limited to, Extensible Markup Language (XML) and JavaScript Object Notation (JSON). Also, the layout reproduction data may be included in the original file of the image laid out.

In S303, the CPU 12 functioning as the output component 23 saves the layout reproduction data file outputted in S302 to the storage server 120 via the network 50. In a storage region such as the RAM 11, an external file, or the like, the CPU 12 stores a uniform resource locator (URL) and a file path of the save location of the layout reproduction data file. The location where the layout reproduction data file is saved may be a storage server accessible only to the layout editing application 20, a cloud storage specified by the user, or the storage device 5 of the information processing apparatus 1. Note that in a case where the layout reproduction data file saved can be migrated to a different save location by a user operation, it is preferable that upon completion of the saving processing, the display control component 22 displays a guidance stating that migrating the file is not recommended.

In S304, the CPU 12 functioning as the output component 23 renders the contents of the layout and outputs a JPEG file. The processing in S304 is the same as the processing described in S310.

In S305, the CPU 12 functioning as the reproduction data processing component 24 writes the save location of the reproduction data in Exchangeable image file format (Exif) included in the JPEG file. For example, the CPU 12 writes, e.g., the URL and the file path of the save location stored in S303 in UserComment (Tag: 37510) in Exif data included in the JPEG file outputted in S304. Note that the location where the information indicating the save location of the layout reproduction data is written is not limited to UserComment in Exif. For example, the save location of the layout reproduction data, such as the URL and the file path, may be written in a metadata region where information can be written freely.

In S306, the CPU 12 functioning as the app ID information adding component 25 adds unique information for identifying the layout editing application 20 to the JPEG image outputted in S304. The unique information for identifying the layout editing application 20 is hereinafter referred to as app ID information (application identification information). A specific example of adding app ID information is described. At the upper layer of bitmap data of the JPEG file outputted in S304, the CPU 12 integrates the icon 60 (see FIG. 2) unique to the layout editing application 20 and re-encodes the JPEG file. Then, the CPU 12 outputs the re-encoded JPEG file to the user-specified save region. Note that similar processing may be performed on the thumbnail image included in the JPEG file as well. Once the processing in S306 is completed, the CPU 12 ends the processing in the flowchart shown in FIG. 3.

Note that in the present embodiment, the look, size, and integration location of the icon integrated with the JPEG file are fixed. The icon may be prepared as an image file or as bitmap data stored in the RAM 11. Also, although a JPEG file is generated and an icon is added to the JPEG file after layout reproduction data is generated and outputted to a save location in the example described in the present embodiment, the order of processing steps is not limited to this. A mode is possible where after an icon is added to a JPEG file, layout reproduction data is outputted to a save location, and the save location is added to Exif in the JPEG file.

FIG. 4 shows an example of a JPEG image where an icon 401 unique to the layout editing application 20 is integrated with the layout edited in FIG. 2. The layout of such a JPEG image can be viewed using, e.g., a typical image viewer application in the OS. In that event, because the icon 401 is integrated, the user can know that layout reproduction data can be referred to.

In the example described above, as an example of adding app ID information, the app ID information adding component 25 adds an icon unique to the layout editing application 20 to a JPEG file representing a layout. The following describes different examples of how app ID information is added.

In a different example, the app ID information adding component 25 may add a character string unique to the layout editing application 20 to the JPEG file name. For example, the app ID information adding component 25 adds a character string related to the application name, such as “_PA_”, to the top of the file name. With this mode, the user can know, based on the file name, that the JPEG image includes layout reproduction data. Note that the character string may be added to the end of the file name.

In another different example, the app ID information adding component 25 may use a character string unique to the layout editing application 20 as the extension of the JPEG file name. For example, the app ID information adding component 25 may use “.jpgpa” as a file name extension or may use “cpfx3.jpg” as a file name extension by adding “.jpg” to the end of the extension of the reproduction data file name. Note that usually, upon receipt of an instruction to open a file with an extension that the OS cannot recognize, the OS prompts the user to select an application to use to read the file. In this case, by selecting an image viewer application in the OS, the user can view the layout image using the image viewer application. This mode allows the user to know, by checking the extension, that the file is image data where the contents of the layout can be viewed and that reproduction data can be refer to from that file.

Note that a certain one of the various modes of app ID information adding modes may be fixed for the layout editing application 20, or the layout editing application 20 may be configured to receive specification of a mode from the user. In a case of receiving specification of a mode from the user, the flowchart shown in FIG. 3 may include a step for receiving user specification, or a mode may be specified by the user prior to the processing in FIG. 3. Note that the app ID information addition mode may be a combination of two or more of the modes exemplified above.

### Layout Reproduction Data Loading Processing

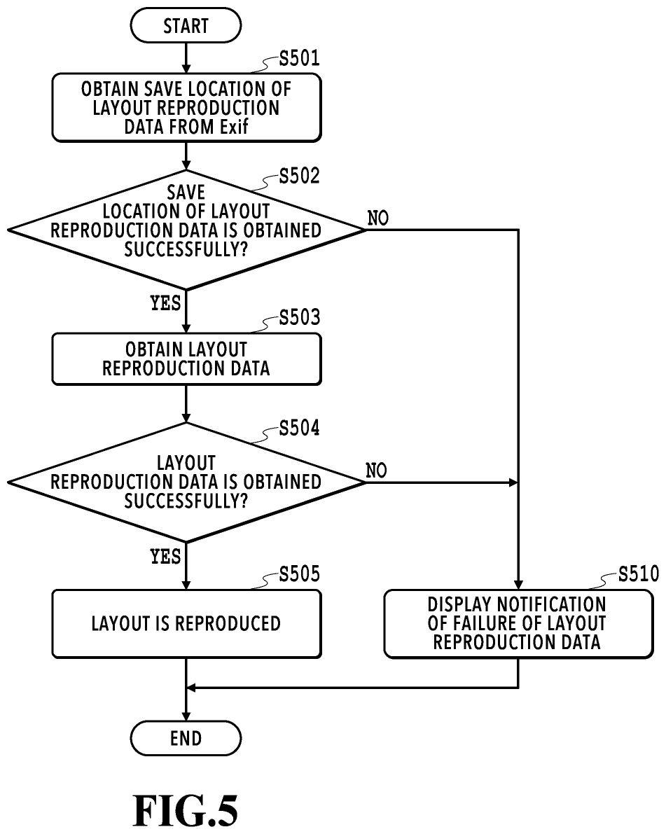

FIG. 5 is a flowchart showing an example of layout reproduction processing. FIG. 5 is used to describe a method of reproducing a layout using an image file which enables reference to layout reproduction data. The processing shown in FIG. 5 is started once the Load Reproduction Data button 41 in FIG. 2 is pressed and a JPEG file in a file list screen displayed is selected. Because the image file is a JPEG file in the present embodiment as described earlier, selection of a JPEG file is used as a trigger in the description of the present processing. However, the file format is not limited to JPEG.

In S501, the CPU 12 functioning as the reproduction data processing component 24 refers to UserComment in Exif data included in the JPEG file and obtains the save location of the layout reproduction data.

In S502, the CPU 12 functioning as the reproduction data processing component 24 determines whether the save location of the layout reproduction data is successfully obtained in S501. The CPU 12 determines that the obtainment is successful if a character string is obtained from UserComment in the Exif data. By contrast, the CPU 12 determines that the obtainment is unsuccessful if a character string is not obtained because, e.g., a character string is empty or the JPEG file includes no Exif data. The CPU 12 proceeds to S503 if the obtainment is determined as successful and proceeds to S510 if the obtainment is determined as unsuccessful.

In S510, the CPU 12 functioning as the display control component 22 displays a guidance stating that loading of layout reproduction data failed. Then, the CPU 12 ends the processing in the flowchart shown in FIG. 5.

In S503, the CPU 12 functioning as the reproduction data processing component 24 refers to the save location of the reproduction data obtained in S501 and obtains the layout reproduction data.

In S504, the CPU 12 functioning as the reproduction data processing component 24 determines whether the layout reproduction data is successfully obtained. The CPU 12 determines that the obtainment is successful if layout reproduction data is obtained normally from the location to which it referred. The CPU 12 determines that the obtainment is unsuccessful if layout reproduction data is not obtained normally from the location to which it referred. The CPU 12 proceeds to S505 if the obtainment is determined as successful and proceeds to S510 if the obtainment is determined as unsuccessful. The processing in S510 is as described earlier.

In S505, the CPU 12 functioning as the reproduction data processing component 24 loads the layout reproduction data obtained and reproduces the layout on the edit screen in FIG. 2. The CPU 12 then ends the processing in the flowchart shown in FIG. 5.

As thus described, the present embodiment can let the user know that reproduction data can be referred to. For example, information related to the layout editing application 20 is integrated with the image file representing a layout, so that the user can know that the image file includes the location to refer to for the layout reproduction data. The information related to the layout editing application 20 may be an icon integrated with the image file or a character string added to the file name of the image file. The image file representing a layout may be migrated from the initially stored location. Also, the image file may be not stored in a storage location unique to the layout editing application 20. Even for an image file of a type having no restraints about file migration, the user can know by checking the image file that the image file includes the location to refer to for the layout reproduction data.

### Second Embodiment

In the example described in the first embodiment, app ID information is added by processing image data (bitmap data) on a JPEG file or its file name. In the present embodiment, an example is described of generating an image which enables a user to know whether layout reproduction data can be referred to, without processing an image file outputted. Note that the basic configuration is the same as the example described in the first embodiment, and the following therefore focuses on differences.

### Image File Outputting Processing

The image file outputting processing in the present embodiment is the processing in the flowchart in FIG. 3 without the processing in S306. In other words, the processing of adding app ID information to an image file representing a layout is not performed. Generated as a result of such image file outputting processing is a JPEG file having the save location of layout reproduction data written in UserComment in Exif data.

### File List Displaying Processing

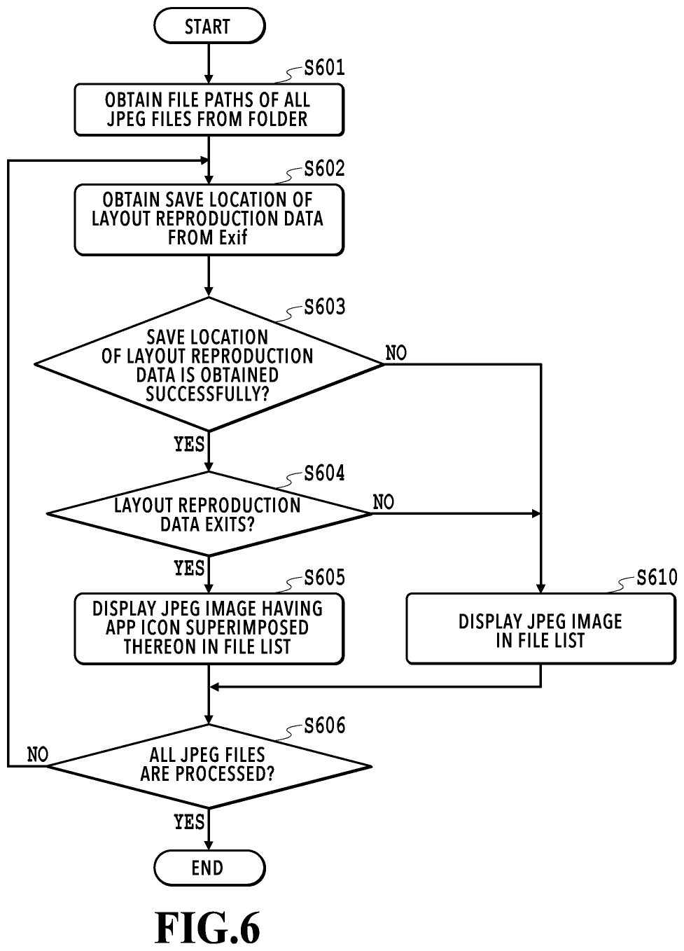

FIG. 6 is a flowchart showing an example of processing of displaying a list of files for loading layout reproduction data. The flowchart shown in FIG. 6 is started once the Load Reproduction Data button 41 in FIG. 2 is pressed and a folder presenting a list of files is selected. Note that this folder may be a folder managed by the OS of the information processing apparatus 1 or a folder in a cloud storage.

In S601, the CPU 12 functioning as the display control component 22 obtains file paths and URLs of all JPEG files from the selected folder. Note that the image format is JPEG in the present embodiment but may be PNG, TIFF, or the like as described in the first embodiment. Also, there may be mixed image formats. Processing in steps after that, namely S602 to S606 and S610, is performed on each of the JPEG files.

In S602, the CPU 12 functioning as the reproduction data processing component 24 refers to UserComment in Exif data included in the JPEG file and obtains the save location of layout reproduction data. In S603, the CPU 12 functioning as the reproduction data processing component 24 determines whether the save location of the reproduction data is obtained in S501. The processing in S602 and S603 is the same processing as that in S501 and S502 in FIG. 5. The CPU 12 proceeds to S604 if it is determined in S603 that the save location of the reproduction data is obtained successfully and proceeds to S610 if it is determined that the obtainment is unsuccessful.

In S610, the CPU 12 functioning as the display control component 22 displays the processing-target JPEG file as an image included in the file list. The JPEG file displayed may be the image itself, a thumbnail included in the JPEG file, or a downsized image. Although an image of a JPEG file is displayed in S610 in the example described, it is to be noted that the CPU 12 may not display a JPEG file in the file list in S610 so that the JPEG file cannot be selected. The processing in FIG. 6 is processing performed upon selection of the Load Reproduction Data button 41, and in a case where layout reproduction data cannot be obtained like in S610, the file may be handled as if it does not exist in the present processing.

In S604, the CPU 12 functioning as the reproduction data processing component 24 refers to the save location of reproduction data obtained in S602 and checks whether there is layout reproduction data. The CPU 12 proceeds to S605 if it is determined that there is layout reproduction data, and proceeds to S610 if it is determined that there is no layout reproduction data.

In S605, the CPU 12 functioning as the display control component 22 displays, as an image included in the file list, an image where an icon unique to the layout editing application 20 is superimposed on the JPEG file. More specifically, the CPU 12 functioning as the app ID information adding component 25 generates an image where an icon unique to the layout editing application 20 is superimposed on the processing-target JPEG file. Then, in the file list, the display control component 22 displays the image generated by the app ID information adding component 25. Note that this JPEG file may be, as described in relation to S610, any of the image itself, a thumbnail, or a downsized image. Also, the superimposed position and size of the icon may be fixed. Note that the present processing is merely processing that changes how a JPEG file is displayed in the presentation of a file list, and the image of the JPEG file itself is not changed.

Also, an icon is integrated as app ID information in the present example described, any of the modes described in S306 in the first embodiment may be used. Specifically, the file name in the file list may be changed by the layout editing application 20, or a file name having app ID information added thereto may be temporarily displayed without the file name itself being changed.

In S606, the CPU 12 functioning as the display control component 22 determines whether all the JPEG files have been processed. The CPU 12 proceeds to S602 if there is an unprocessed JPEG file. If all the JPEG files have been processed, the CPU 12 ends the processing in the flowchart shown in FIG. 6.

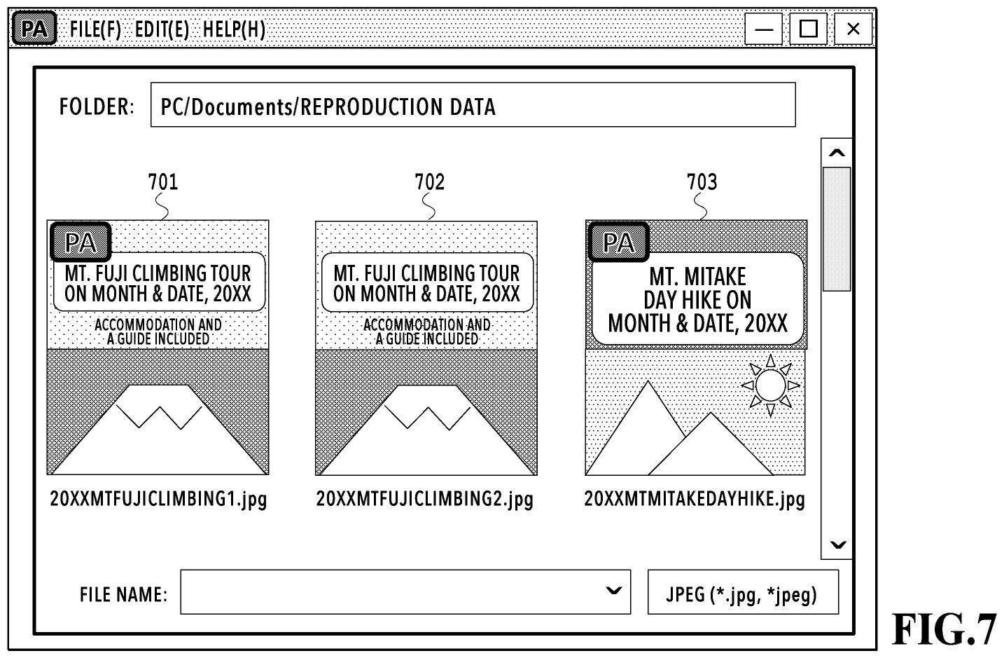

FIG. 7 is a diagram showing an example where a file list is displayed with all the JPEG files having been processed. An image 701 and an image 703 are images displayed after going through the processing in S606 and have an icon superimposed thereon. An image 702 is an image displayed after going through S610 and has no icon superimposed thereon. Once any of the images is selected, the processing in the flowchart shown in FIG. 5 described in the first embodiment is executed. In a case where the image 701 or the image 703 is selected, a layout is reproduced by the layout editing application 20, and in a case where the image 702 is selected, a guidance is displayed stating that loading of reproduction data has failed.

As thus described above, the present embodiment also can let the user know that reproduction data can be referred to. Specifically, in the present embodiment, app ID information is not added to the image files themselves, and in displaying a file list, the layout editing application 20 outputs an image file having app ID information added thereto. By checking the image file included in the file list, a user can know that an image file includes the location to refer to for layout reproduction data.

### Third Embodiment

In the example described in the first embodiment, a JPEG file which enables reference to layout reproduction data is outputted in a form where it can be referred to by any user. A JPEG file which enables reference to layout reproduction data can be readily distributed to users other than the creator of the layout through, e.g., an email or a cloud storage service. The present embodiment describes an example where the creator of a layout can give access control to the layout reproduction data so that only a particular user can reproduce the layout. The basic configuration is the same as the example described in the first embodiment and is therefore not described, and the following focuses on differences.

### Image File Outputting Processing

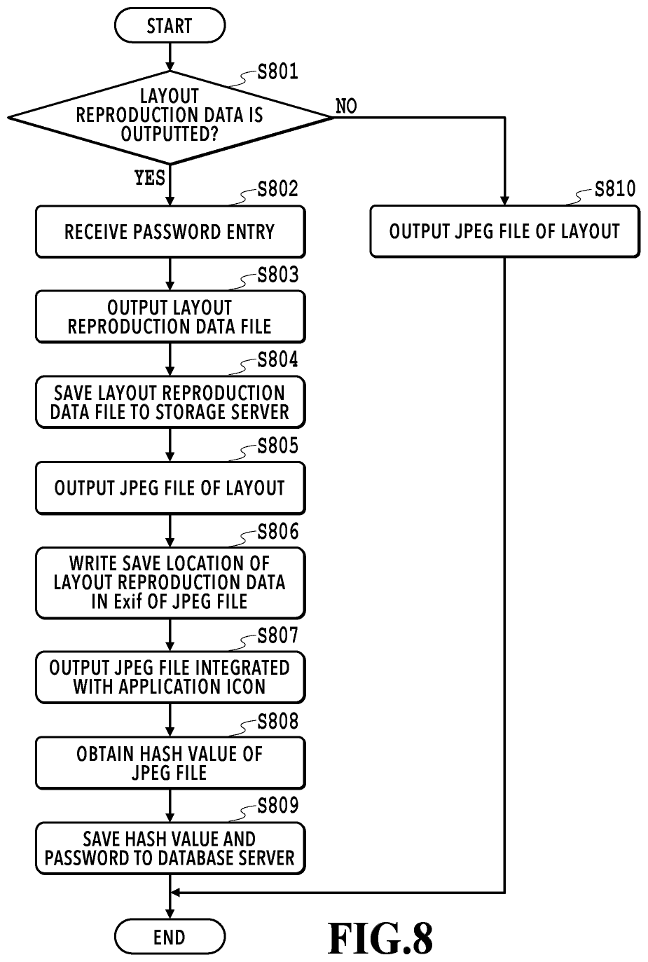

FIG. 8 is a flowchart showing an example of image file outputting processing. FIG. 8 is used to describe processing of creating layout reproduction data with access control. The flowchart in FIG. 8 is processing started upon pressing of the Save button 74 shown in FIG. 2.

S801 is the same determination processing as S301 in FIG. 3. In a case where layout reproduction data is not outputted, but an image file is outputted, the CPU 12 proceeds to S810. S810 is the same processing as S310 in FIG. 3. Once S810 ends, the CPU 12 ends the processing in the flowchart shown in FIG. 8. The CPU 12 proceeds to S802 if the determination result in S801 is outputting layout reproduction data.

In S802, the CPU 12 functioning as the display control component 22 displays a password entry form and receives a password entered by the user. Next, S803 to S807 are the same processing as S302 to S306 in FIG. 3. After S807, the CPU 12 proceeds to S808.

In S808, using a hash generation method such as the message-digest algorithm 5 (MD5), the CPU 12 functioning as the reproduction data processing component 24 obtains a hash value unique to the JPEG file outputted in S807.

In S809, the CPU 12 functioning as the reproduction data processing component 24 pairs the password received in S802 with the hash value obtained in S808 and stores the pair in the database server 130. For example, the database server 130 stores the pair in a dictionary form using the hash value as a key and the password as a value. Once the processing in S809 is completed, the CPU 12 ends the processing in the flowchart shown in FIG. 8.

### Layout Reproduction Data Loading Processing

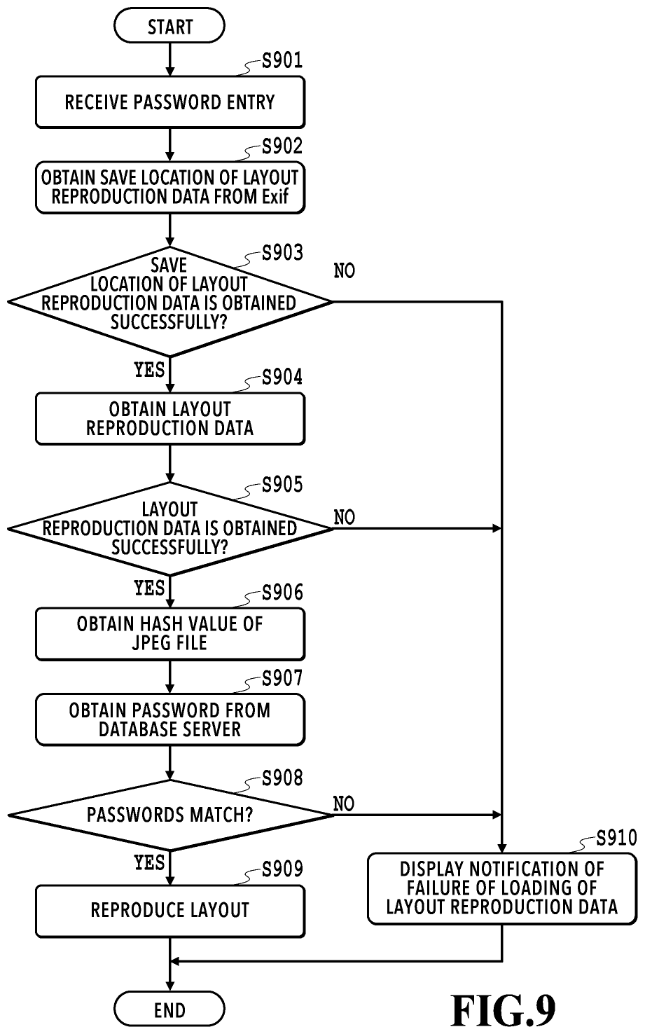

FIG. 9 is a flowchart showing an example of layout reproduction processing. The flowchart in FIG. 9 is used to describe processing of loading layout reproduction data with access control. The flowchart in FIG. 9 is started once the Load Reproduction Data button 41 in FIG. 2 is pressed and a JPEG file is selected on a file list screen.

In S901, the display control component 22 displays a password entry form and receives a password entered by the user. Next, S902 to S905 are the same processing as S501 to S504 in FIG. 5. If it is determined in S905 that layout reproduction data is obtained successfully, the CPU 12 proceeds to S906.

In S906, the CPU 12 functioning as the reproduction data processing component 24 obtains a hash value of the processing-target JPEG file selected at the start of the processing in FIG. 9 using MD5.

In S907, the CPU 12 functioning as the reproduction data processing component 24 obtains, from the database server 130, a password pairing with the hash value obtained in S906. For example, in a case where the data is stored in a dictionary form in S809, the reproduction data processing component 24 can obtain a password from the database server 130 by using the hash value as a key. Note that in a case where a hash value cannot be obtained, the value of a password is stored as an empty string or null.

In S908, the CPU 12 functioning as the reproduction data processing component 24 determines whether the password received in S901 matches the password obtained in S907. If neither of the passwords is an empty string or null and if the character strings of both passwords match, the CPU 12 proceeds to S909, and otherwise, the CPU 12 proceeds to S910. S910 is the same processing as S510 in FIG. 5. Note that in S910 in the present embodiment, it is preferable to display a guidance stating that the password is invalid, in addition to displaying a guidance stating that loading of layout reproduction data has failed.

S909 is the same processing as S505 in FIG. 5. Specifically, the layout is presented on the edit screen in FIG. 2. Upon completion of the processing in S909, the CPU 12 ends the processing in the flowchart shown in FIG. 9.

As thus described, the present embodiment can control the access authority to use layout reproduction data. This enables only a user who knows the password which was set up in the output of the image file representing the layout to unlock the access control and reproduce the layout using the layout reproduction data.

Note that how to enable only a user who knows the password to reproduce a layout is not limited to the example described in the present embodiment as long as a password and a JPEG file or a password and layout reproduction data can be linked to each other. Although a JPEG file and a password are linked in the example described in the present embodiment, a layout reproduction data file and a password may be linked. For example, in S808 and S906, the layout editing application 20 may obtain a hash value of layout reproduction data.

Also, as a different example, layout reproduction data may be saved after encrypted using AES-256 with the password used as a key. One example method is to save layout reproduction data as a password-protected ZIP file. Layout reproduction data may be configured as follows: in saving of the layout, the layout reproduction data is zipped with the password received in S802, and in loading of the JPEG file, the layout can be reproduced in a case where the ZIP file can be uncompressed using the password received in S901.

Although the present embodiment is described based on the example described in the first embodiment, the present embodiment may employ a mode where a password is set up based on the example described in the second embodiment. Specifically, the following configuration is possible. In the image file outputting processing, the processing in S807 in FIG. 8 is skipped. Then, in the file list displaying processing, the processing described in the second embodiment is performed, and after that, the processing shown in FIG. 9 is performed upon selection of a JPEG file.

### Fourth Embodiment

In the examples described in the embodiments thus far, the content, displayed position, size, and the like of an icon for a JPEG file are fixed, the icon indicating that the JPEG file enables reference to layout reproduction data. The present embodiment describes an example where an icon integrated with or superimposed and displayed on a JPEG image is not fixed and can be modified by a user as needed. The basic configuration and the like are the same as those in the examples described in the embodiments above and are therefore not described, and the following focuses on differences.

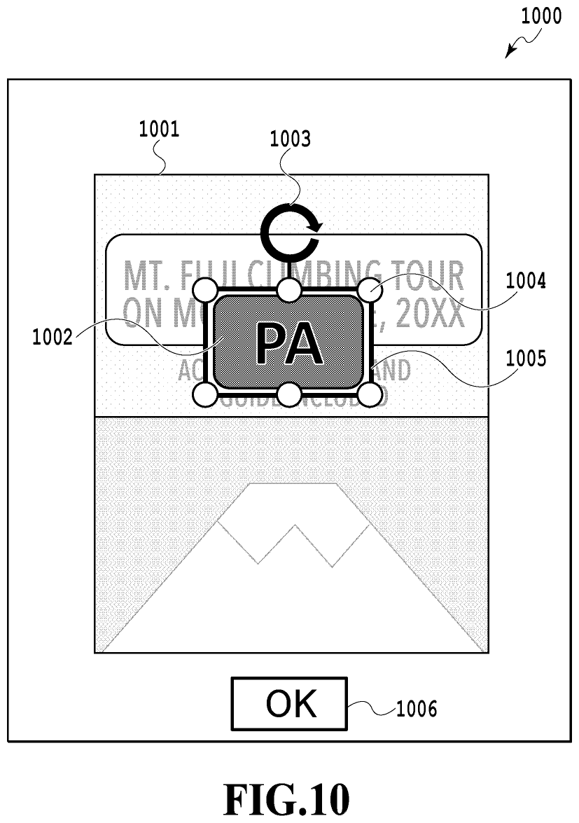

FIG. 10 is a diagram showing an example screen for editing an icon. FIG. 10 shows a UI screen 1000 for setting the superimposed position, size, and rotation direction of an icon superimposed on a JPEG image. A preview screen 1001 shows a preview of content currently laid out. An icon 1002 is an icon unique to the layout editing application 20. In this example, the icon is the same as that described in the first embodiment and the like. A mark 1003 is a mark for changing the rotation direction of the icon. Dragging the mark 1003 determines the direction of rotation. A mark 1004 is a mark for resizing the icon. Dragging the mark 1004 changes the size and aspect ratio of the icon. A region 1005 is a rectangular region encompassing the icon 1002. Dragging the edge or inside of the region 1005 moves the position of the icon 1002 disposed. A region 1006 is a region showing a button for confirming the changes to the icon and closing the UI screen 1000. The UI screen 1000 shown in FIG. 10 may be configured to be opened while a layout is being edited on the layout editing application 20 or opened while an operation for saving layout reproduction data is performed.

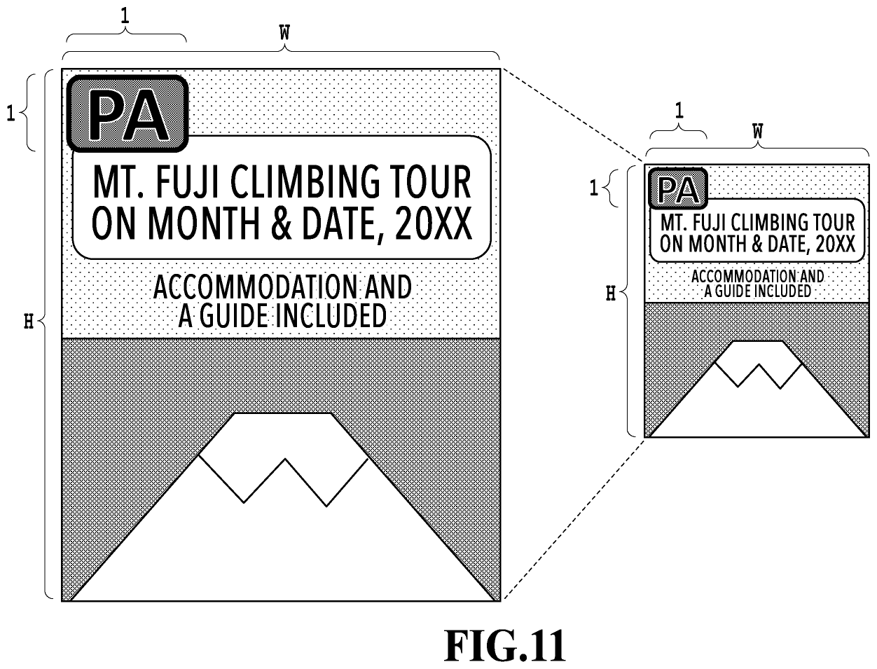

FIG. 11 is a diagram showing an example screen for editing an icon. FIG. 11 is used to describe a different example of editing. FIG. 11 shows an example where the size of the icon is determined according to the size, such as vertical and horizontal pixel counts, of an image showing a layout (a layout image). The size of an icon is adjusted to be a certain size relative to the size of the layout image. For example, the vertical size of the icon is determined to be 1/H of the vertical size H of the layout image, and the horizontal size of the icon is determined to be 1/W of the horizontal size W of the layout image. Note that in the adjustment, the aspect ratio of an icon may be fixed or may be adjusted to have the same aspect ratio as the layout image.

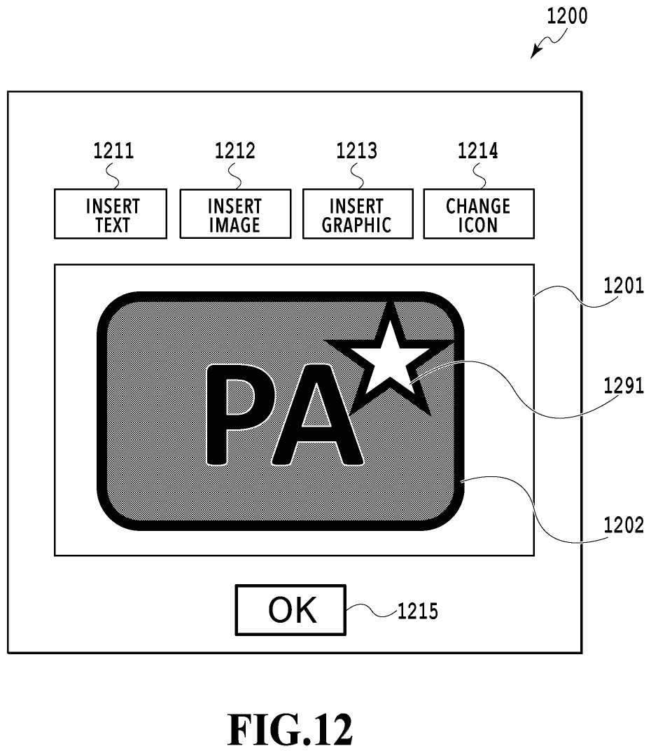

FIG. 12 is a diagram showing an example icon edit screen. FIG. 12 is used to describe a different example. FIG. 12 shows a UI screen 1200 for selecting and editing an icon itself. The UI screen 1200 has an icon edit region 1201. The edit region 1201 displays an icon 1202 to be edited. Buttons 1211 to 1213 show button regions for performing layout operations in the edit region 1201. For example, an Insert Text button 1211 is a button for receiving an instruction to insert text to the edit region 1201. An Insert Image button 1212 is a button for receiving an instruction to insert an image to the edit region 1201. An Insert Graphic button 1213 is a button for receiving an instruction to insert a graphic to the edit region 1201. A Change Icon button 1214 is a button for receiving an instruction to change an icon. A graphic 1291 is a graphic inserted based on pressing of the Insert Graphic button 1213.

For example, upon pressing of the Change Icon button 1214, the layout editing application 20 displays an image selection screen and can change the image of the icon 1202 to an image selected by the user. Note that the selected image is preferably a design indicating that the file is a reproduction data file of the layout editing application 20. A region 1215 is a button for confirming the edits to the icon and closing the UI screen 1200. The UI screen 1200 may be configured to open during editing of a layout on the layout editing application 20 or during an operation to save layout reproduction data. Also, although not shown on the UI screen 1200, edit functions of the layout editing application 20 may be included in the UI screen 1200. The edit functions are, for example, trimming an image, making a partial region transparent, replacing a particular color with a different color, drawing a line freehand, and filling an object with a color.

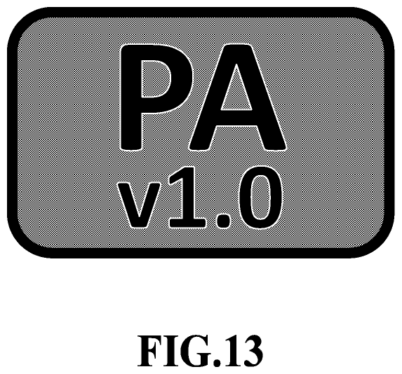

FIG. 13 is a diagram showing another example of an icon. FIG. 13 shows an example where an icon includes a notation of version information on the layout editing application 20. Examples of the version notation include the application version of the layout editing application 20 at the time of creation of the layout or the version of the layout editing application 20 capable of loading layout reproduction data. After a version upgrade of the layout editing application 20, the layout editing application 20 may no longer be able to support layout reproduction data in earlier versions. In such a case, by referring to the version included in the icon, the user can check compatibility with the layout editing application 20 currently available.

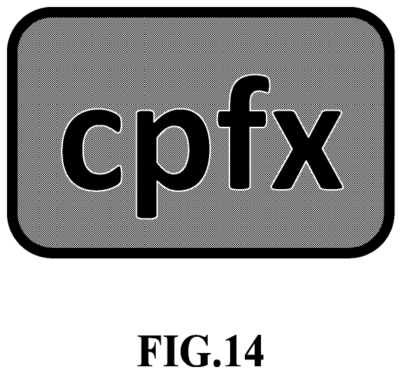

FIG. 14 is a diagram showing another example of an icon. FIG. 14 shows an example where an icon includes a notation of the extension of a layout reproduction data file. Including a notation of an extension is especially effective in a case where the extension is unique to the layout editing application 20. Also, an icon may include both a notation of an extension and a notation of version information.

### Other Embodiments

The embodiments described above use a layout editing application as an example of a program and use layout reproduction data as an example of data to refer to. However, the present disclosure is not limited to this example. Any mode may be employed as long as the state of a screen at the time of a pause of the application (which may be a capture screen) is outputted as an image file with reproduction data for reproducing the configuration at the time of the pause of the application being included in the outputted image file as a location to refer to. For example, the application may be a program emulating a game program.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-011963, filed Jan. 30, 2024, which is hereby incorporated by reference herein in its entirety.

What is claimed is:

1. An information processing apparatus comprising:
one or more memories storing instructions; and
one or more processors executing the instructions to:
perform output processing of outputting reproduction data to a save location, the reproduction data being for reproducing a layout created using a layout editing application;
perform generation processing of generating an image file related to the layout;
perform first addition processing of adding information indicative of the save location to the image file generated in the generation processing; and
perform second addition processing of adding identification information for identifying the layout editing application to the image file.

2. The information processing apparatus according to claim 1, wherein
in the output processing, the reproduction data is outputted to the save location outside the information processing apparatus.

3. The information processing apparatus according to claim 1, wherein
in the output processing, the reproduction data is outputted to the save location inside the information processing apparatus.

4. The information processing apparatus according to claim 1, wherein
in the first addition processing, the information indicative of the save location is added as metadata of the image file.

5. The information processing apparatus according to claim 1, wherein
in the first addition processing, the information indicative of the save location is added to Exif of the image file.

6. The information processing apparatus according to claim 1, wherein
in the second addition processing, an icon indicative of the layout editing application is integrated with the image file as the identification information.

7. The information processing apparatus according to claim 6, wherein
the icon is a preset, fixed icon.

8. The information processing apparatus according to claim 6, wherein
the icon includes a notation of a version of the layout editing application that outputs the reproduction data.

9. The information processing apparatus according to claim 6, wherein
the icon includes a notion of a version of the layout editing application capable of reproducing the layout using the reproduction data.

10. The information processing apparatus according to claim 6, wherein
the one or more processors further execute the instructions to perform edit processing of editing the icon.

11. The information processing apparatus according to claim 10, wherein
in the edit processing, at least one of a position and a size of the icon integrated with the image file is edited.

12. The information processing apparatus according to claim 10, wherein
in the edit processing, at least one of any selected text, any selected graphic, and any selected image is edited as the icon.

13. The information processing apparatus according to claim 10, wherein
in the edit processing, the icon is edited so that an aspect ratio of the icon is adjusted according to an aspect ratio of the image file.

14. The information processing apparatus according to claim 6, wherein
in the second addition processing, a thumbnail integrated with the icon is added to the image file.

15. The information processing apparatus according to claim 1, wherein
in the second addition processing, a character string indicative of the layout editing application is added to a file name of the image file as the identification information.

16. The information processing apparatus according to claim 1, wherein
in the second addition processing, an extension indicative of the layout editing application is added to an extension of the image file as the identification information.

17. The information processing apparatus according to claim 1, wherein
the one or more processors further execute the instructions to
perform reception processing of receiving an instruction from a user and
perform obtainment processing of obtaining the reproduction data based on information indicative of the save location added to the image file.

18. The information processing apparatus according to claim 17, wherein
the one or more processors further execute the instructions to control the output processing, the generation processing, the first addition processing, and the second addition processing upon reception of an instruction to save the layout in the reception processing.

19. A method for controlling an information processing apparatus, the method comprising:
outputting reproduction data to a save location, the reproduction data being for reproducing a layout created using a layout editing application;
generating an image file related to the layout;
adding information indicative of the save location to the image file generated in the generating; and
adding identification information for identifying the layout editing application to the image file.

20. A non-transitory computer-readable storage medium storing a program which causes a computer to execute:
outputting reproduction data to a save location, the reproduction data being for reproducing a layout created using a layout editing application;
generating an image file related to the layout;
adding information indicative of the save location to the image file generated in the generating; and
adding identification information for identifying the layout editing application to the image file.
